(19) United States
(12) Patent Application Publication
(10) Pub. No.: US 2004/0192389 A1
(43) Pub. Date: Sep. 30, 2004

(54) Array antenna system in mobile communication

(76) Inventors: Il-Gyu Kim, Seoul (KR); Hyeong-Geun Park, Daejeon (KR); Jun-Hwan Lee, Seoul (KR); Hye-Kyung Jwa, Daejeon (KR); Hong-Sup Lee, Seoul (KR); Seung-Chan Bang, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/334,927

(22) Filed: Dec. 31, 2002

(30) Foreign Application Priority Data
Oct. 7, 2002 (KR) 2002-60988

(51) Int. Cl. H04M 1/00; H04B 1/38

(52) U.S. Cl. 455/561; 455/562.1

(57) ABSTRACT

Disclosed is a mobile array antenna system that comprises: a signal converter for performing frequency downconversion and digital signaling on radio signals received through a plurality of array antennas in multiple paths, converting the signals into analog signals, and performing frequency upconversion; and a baseband unit for using the signals output from the signal converter to generate receiving beam-forming signals having equal power levels, performing temporal and spatial dispreading, channel estimation, coherent demodulation, combining and decoding to output final signals, receiving signals for wireless transmission, performing channel encoding on them, modulating the channel encoded signals, generating transmission beam-forming signals, and outputting them to the signal converter.

### CROSS REFERENCE TO RELATED APPLICATION

This application is based on Korea Patent Application No. 2002-60988 filed on Oct. 7, 2002 in the Korean Intellectual Property Office, the content of which is incorporated herein by reference.

### BACKGROUND OF THE INVENTION

(a) Field of the Invention

The present invention relates to a smart antenna. More specifically, the present invention relates to an array antenna system for concurrently performing temporal and spatial processing to minimize multiple access interference under a CDMA (code division multiple access) system environment.

(b) Description of the Related Art

In general, signals received during mobile communication include original signals and interference signals, and a single original signal is conventionally matched with a plurality of interference signals. Since the degree of communication distortion caused by the interference signals is determined by the summation of power of the original signal and power of all interference signals, if the number of interference signals is large even when the level of the original signal is substantially higher than each level of the interference signals, the total power of the interference signals becomes significant, thereby generating communication distortion.

Therefore, conventional wireless communication systems, and in particular mobile communication systems, use an array antenna system to minimize the interference signals. That is, when a moving object moves or when AOAs(Angle Of Arrival) of the signals are variable depending on each individual situation, the conventional mobile communication systems use an array antenna including a plurality of antenna elements to detect positions of long-distance signal sources, or they controls phases of the array antenna to selectively transmit and receive the original signals output from the antenna elements, and therefore effects of the interference signals are minimized to greatly reduce the interference between subscribers.

FIG. 1 shows a conventional array antenna system for a CDMA system.

As shown, the CDMA array antenna system comprises a signal converter 10 and a baseband unit 20.

The signal converter 10 amplifies radio signals that are externally received through an array antenna 11 including Nₐₙₜₑₙₙₐ antenna elements, down-converts frequencies, converts them into digital signals, and outputs the digital signals to the baseband unit 20.

The baseband unit 20 comprises a beam former 21 for converting the Nₐₙₜₑₙₙₐ signals output from the signal converter 10 into N_{beam} forming signals; a finger bank 23 for temporally and spatially dispreading the N_{beam} forming signals converted and output from the beam former 21, estimating a channel, performing a coherent demodulation, and outputting signals; a combiner/decoder bank 25 for combining and decoding the output signals of the finger bank 23, and outputting results to a digital demodulator (not illustrated); a beam path searcher 27 for using N_{beam} switching beam forming signals output from the beam former 21 to search a beam path; and a controller 29 for controlling the operation of the finger bank 23 according to output signals of the beam path searcher 27.

The above-described conventional CDMA array antenna system includes an adaptive beam array antenna system and a switching beam array antenna system. The adaptive beam array antenna system has the same number of beams and fingers, and the switching beam array antenna system has a different number of beams and fingers at a receiver. Also, the switching beam array antenna system uses at least one beam-forming signal as at least one finger input.

The signal converter 10 uses an AD converter for converting analog signals into digital signals. When signals of a very low level are input to the AD converter, a quantization noise is generated which reduces the performance of the whole system, and when the level of the signals is very high, it exceeds the maximum value of the AD converter and generates a huge error. Therefore, an AGC (automatic gain control) loop is used so as to control the levels of the signals input to the AD converter to be constant.

However, when the AGC is performed for each array antenna 11 or for all the antennas in the conventional CDMA array antenna system, respective signal levels of the N_{beam} switching beam-forming signals input to the finger bank 23 of the baseband unit 20 may be substantially different, and as a result, the interference density for each beam becomes different, and the combiner may not perform an optimized combination so that the performance of the array antenna system is significantly lowered.

Further detailed description will be provided with reference to FIGS. 2 and 3.

FIG. 2 shows an exemplified case in which an array antenna system having four switching beams is applied to a base station receiver 30, and FIG. 3 shows power for each beam-forming signal output from the beam former 21 and input to the finger bank 23 under the state of FIG. 2.

When the conventional array antenna system having the configuration of FIG. 1 installed in the base station receiver 30 has a different number of mobile stations 31 as shown in FIG. 2, the total power of the receiving signals of each beam are respectively different, as shown in FIG. 3.

Since the second beam 32b has the most mobile stations 31 in FIG. 2, the received signal level of the second beam 32b, that is, the received power, becomes the biggest as shown in FIG. 3.

When receiving the signals from a predetermined single mobile station 31 through multiple paths, that is, through two beams including the second beam 32b and the third beam 32c, the beam former 21 of the conventional array antenna system outputs respective beam-forming signals having different magnitudes of received signal levels, the finger bank 23 allocates the beam-forming signals output from the beam former 21 to different fingers to perform coherent demodulation and to output demodulated signals, and the combiner/decoder bank 25 combines the demodulated signals output from the finger bank 23 and outputs combined signals.

Accordingly, since the conventional array antenna system for directly allocating the beam-forming signals with different received signal levels as the finger inputs has different interference densities per beam, the combiner/decoder bank 25 fails to combine the signals in an optimized manner, thereby greatly lowering the receiving performance.

### SUMMARY OF THE INVENTION

It is an object of the present invention to provide a mobile array antenna system for maximizing the array antenna s receiving performance by equating the powers of the receiving signals for respective beams.

In one aspect of the present invention, an array antenna system in mobile communication comprises: a signal converter for performing frequency downconversion and digital signaling on radio signals received from multiple paths through a plurality of array antennas; and a baseband unit for using signals output from the signal converter to generate beam-forming signals having equal power levels, temporally and spatially performing dispreading, performing channel estimation, performing coherent demodulation, and performing combining and decoding to output final signals.

The signal converter comprises: a frequency converter for respectively amplifying the signals received through the array antennas, downconverting the frequency, and outputting signals; an A/D converter for converting the respective signals output from the frequency converter into digital signals and outputting the digital signals to the baseband unit; and an automatic gain controller for controlling the frequency converter on the basis of the respective output signals of the A/D converter so that the respective signals output to the A/D converter from the frequency converter may be matched with an input level of the A/D converter.

The baseband unit comprises: a beam former for using the respective signals output from the signal converter to change them into beam-forming signals of a predetermined number, and outputting changed signals; a beam gain controller for receiving the beam-forming signals from the beam former, controlling power levels for the respective beams to be equal, and outputting signals; a finger bank for temporally and spatially dispreading the beam-forming signals output from the beam gain controller, performing channel estimation, and performing coherent demodulation; a combiner/decoder bank for performing combining and decoding of the output signals of the finger bank, and outputting final signals to a digital demodulator; a beam path searcher for using the beaming forming signals output from the beam gain controller to perform a beam path search; and a controller for controlling the operation of the finger bank according to output signals of the beam path searcher.

The beam gain controller comprises: a multiplier for multiplying the beam-forming signals output from the beam former by a predetermined gain control signal, and outputting result signals to the finger bank; a power measurer for measuring power levels of the respective signals output from the multiplier; and a gain controller for outputting the gain control signal to the multiplier for each beam-forming signal so that the power levels of the respective signals measured by the power measurer may be equal.

The ratios of the reciprocals of the gain control signals for the respective beam-forming signals with the predetermined number output to the multiplier from the gain controller become the power ratios of the beam-forming signals with the predetermined number output from the beam former.

In another aspect of the present invention, an array antenna system for mobile communication comprises: a baseband unit for receiving signals input for mobile transmission, performing channel encoding on them, modulating the channel encoded signals on the basis of information on power ratios of externally input receiving beam-forming signals, generating transmission beam-forming signals, and outputting them; and a signal converter for converting the signals output from the baseband unit into analog signals, upconverting the frequency, and wirelessly transmitting the analog signals through a plurality of array antennas in multiple paths.

The baseband unit comprises: a channel encoder bank for using a code matched with the input signal to perform channel encoding; a modulator bank for using information of the power ratios of the externally input receiving beam-forming signals to control power levels of the respective signals input from the channel encoder bank, and outputting signals; and a beam former for changing the signals output from the modulator bank into transmission beam-forming signals of a predetermined number, and outputting the signals to the signal converter.

The signal converter comprises: a D/A converter for converting the signals output from the baseband unit into analog signals, and outputting them; and a frequency converter for performing frequency upconversion on the signals output from the D/A converter, and wirelessly transmitting them to the outside through the array antennas.

The information on the power ratios of the externally input receiving beam-forming signals is generated on the basis of the power level information measured from the receiving beam-forming signals generated from radio receiving signals.

In still another aspect of the present invention, a mobile array antenna system comprises: a signal converter for receiving radio signals through a plurality of array antennas in multiple paths, performing frequency downconversion on them, performing digital signaling, converting the signals input for wireless transmission through the array antennas into analog signals, and performing frequency upconversion; and a baseband unit for using the signals output from the signal converter to generate receiving beam-forming signals having equal power levels, temporally and spatially performing dispreading, performing channel estimation, performing coherent demodulation, and performing combining and decoding to output final signals, and receiving input signals for wireless transmission, performing channel encoding on them, modulating the channel encoded signals, generating transmission beam-forming signals, and outputting them to the signal converter on the basis of information on the power levels of the receiving beam-forming signals used for the receiving beam-forming signals to have equal power levels.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a block diagram of a conventional CDMA array antenna system;

FIG. 2 shows an exemplification for applying an array antenna system with four switching beams to a base station receiver;

FIG. 3 shows powers for respective beam-forming signals output from a beam former and input to a finger bank under the state of FIG. 2;

FIG. 4 shows a block diagram of an array antenna system for mobile communication according to a preferred embodiment of the present invention;

FIG. 5 shows powers of signals output from a beam gain controller and input to a finger bank when the preferred embodiment of the present invention is applied under a state such that the number of mobile stations is different for each beam in the case of the four switching beams as shown in FIG. 2; and

FIG. 6 shows a block diagram of an array antenna system for mobile communication according to a second preferred embodiment of the present invention.

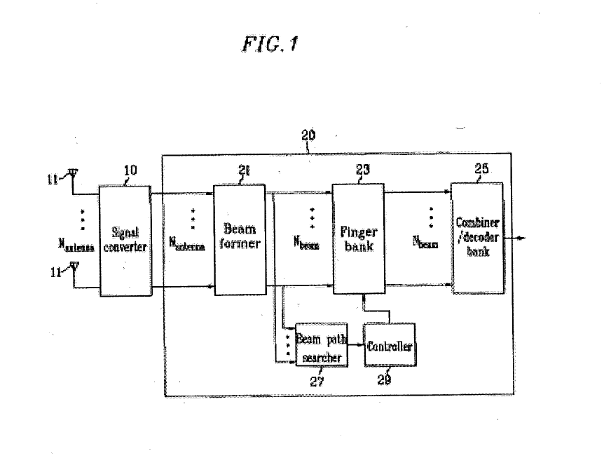

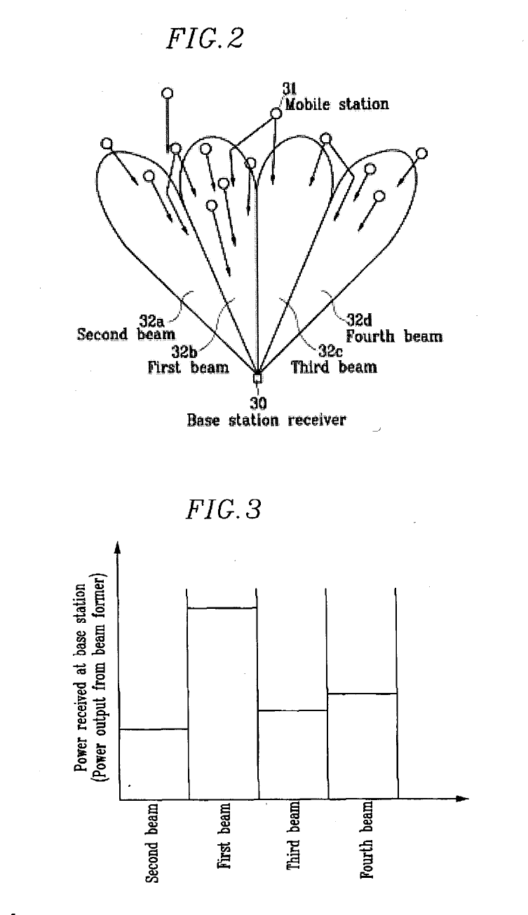

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

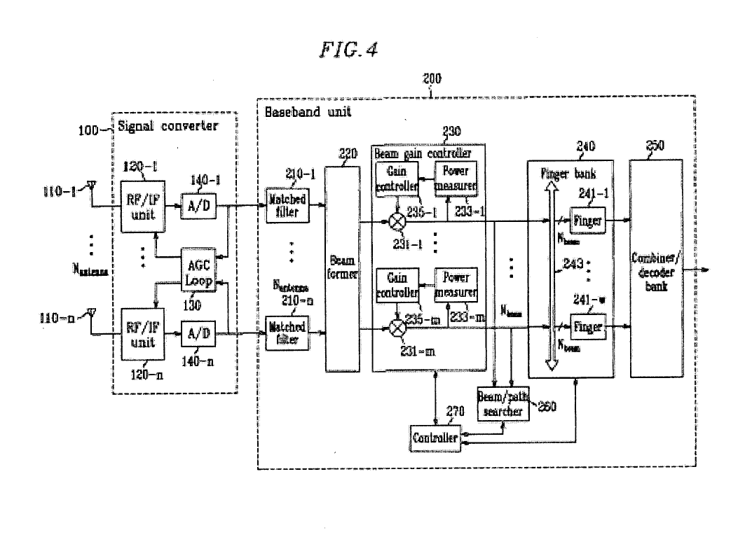

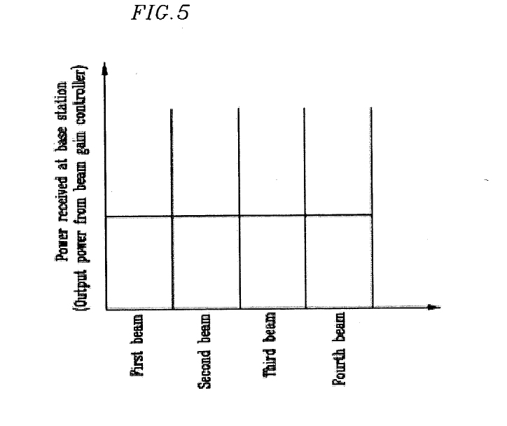

FIG. 4 shows a block diagram of an array antenna system for mobile communication according to a preferred embodiment of the present invention.

As shown, the array antenna system comprises a signal converter 100 and a baseband unit 200.

The signal converter 100 externally and wirelessly receives RF (radio frequency) signals through array antennas 110-1 through 110-n including Nₐₙₜₑₙₙₐ (=n) antenna elements, amplifies the RF signals, downconverts a corresponding frequency to an IF (intermediate frequency), converts the signals into digital signals, and outputs them to the baseband unit 200.

The signal converter 100 comprises RF/IF units 120-1 through 120-n, A/D converters 140-1 through 140-n, and an AGC loop unit 130.

The RF/IF units 120-1 through 120-n amplify the RF signals that are externally and wirelessly received through the array antennas 110-1 through 110-n, downconverts the frequency into an IF, and outputs IF signals.

The A/D converters 140-1 through 140-n convert the IF signals output from the RF/IF units 120-1 through 120-n into digital signals, and output the digital signals to the baseband unit 200.

The AGC loop unit 130 controls the RF/IF units 120-1 through 120-n on the basis of the respective output signals of the A/D converters 140-1 through 140-n, so that the IF signals output from the RF/IF units 120-1 through 120-n to the A/D converters 140-1 through 140-n may be matched with input levels of the A/D converters 140-1 through 140-n.

The baseband unit 200 uses the signals output from the signal converter 100 to generate switching beam-forming signals having equal power levels, temporally and spatially dispreads them, performs channel estimation, performs coherent demodulation, performs combining and decoding, and outputs final signals.

The baseband unit 200 comprises matched filters 210-1 through 210-n, a beam former 220, a beam gain controller 230, a finger bank 240, a combiner/decoder bank 250, a beam path searcher 260, and a controller 270.

The matched filters 210-1 through 210-n match the digital signals output from the A/D converters 140-1 through 140-n of the signal converter 100.

The beam former 220 changes n signals output from the matched filters 210-1 through 210-n into N_{beam} (=m) switching beam-forming signals by using N_{beam}(=m)×n correlators.

The beam gain controller 230 receives the m beam-forming signals from the beam former 220, controls the power levels of the respective beams to be equal, and outputs the equal power levels.

The finger bank 240 temporally and spatially dispreads the m switching beam-forming signals output from the beam gain controller 230, performs channel estimation, and performs coherent demodulation.

The combiner/decoder bank 250 performs combining and decoding on the output signals of the finger bank 240, and finally outputs result signals to a digital demodulator (not illustrated.)

The beam path searcher 260 uses the m switching beam-forming signals output from the beam gain controller 230 to search beam paths.

The controller 270 controls the operation of the finger bank 240 according to output signals of the beam path searcher 260.

In this instance, the beam gain controller 230 comprises multipliers 231-1 through 231-m, power measurers 233-1 through 233-m, and gain controllers 235-1 through 235-m.

The multipliers 231-1 through 231-m respectively receive m beam-forming signals from the beam former 220, multiply them by respective outputs of the gain controllers 235-1 through 235-m, and output multiplied signals to the finger bank 240.

The power measurers 233-1 through 233-m measure power levels of the signals output from the multipliers 231-1 through 231-m, and output results to the corresponding gain controllers 235-1 through 235-m.

The gain controllers 235-1 through 235-m provide output signals for controlling the power levels of the signals output from the power measurers 233-1 through 233-m to be matched with a predetermined reference level to the multipliers 231-1 through 231-m so that the power levels of the signals may be made equal. In this instance, the predetermined reference level may be modified according to control of the controller 270.

Therefore, a ratio of reciprocals of the signals output to the multipliers 231-1 through 231-m from the gain controllers 235-1 through 235-m becomes a power ratio of the m beam-forming signals output from the beam former 220.

The finger bank 240 comprises w fingers 241-1 through 241-w, and the respective fingers 241-1 through 241-w receive m signals from the multipliers 231-1 through 231-m of the beam gain controller 230 through a bus 243, temporally and spatially dispread the m signals, perform channel estimation, perform coherent demodulation, and output w signals to the combiner/decoder bank 250.

The beam gain controller 230 uses the power measurers 233-1 through 233-m, the gain controllers 235-1 through 235-m, and the multipliers 231-1 through 231-m to control the power levels of the m signals output from the beam former 220 to be equal.

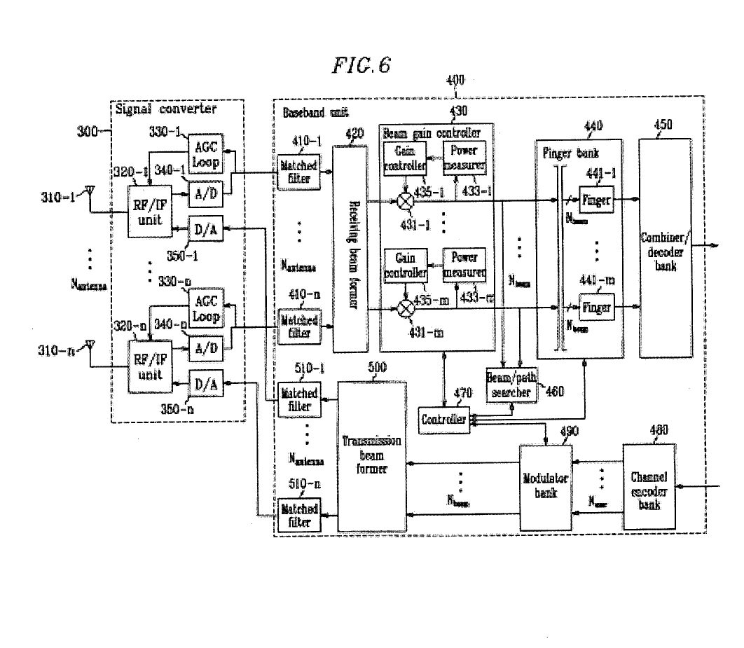

FIG. 5 shows powers of signals output from a beam gain controller and input to a finger bank when the preferred embodiment of the present invention is applied under the state such that the number of the mobile stations is different for each beam in the case of the four switching beams as shown in FIG. 2.

As shown, the power levels of the received signals for each beam are maintained to be equal by providing a beam gain controller 230 between the beam former 220 and the finger bank 240, and accordingly, the combiner/decoder bank 250 performs a maximal ratio combination to maximize the performance of the array antenna system.

FIG. 6 shows a block diagram of an array antenna system for mobile communication according to a second preferred embodiment of the present invention.

As shown, the mobile array antenna system comprises a signal converter 300 and a baseband unit 400.

The signal converter 300 amplifies the RF signals that are externally and wirelessly received through array antennas 310-1 through 310-n including antenna elements, downconverts the frequency into an IF, converts the signals into digital signals, outputs them to the baseband unit 400, and receives IF signals from the baseband unit 400, converts them into analog signals, upconverts the frequency into an RF, and wirelessly transmits the RF signals through the array antennas 310-1 through 310-n.

The signal converter 300 comprises RF/IF units 320-1 through 320-n, A/D converters 340-1 through 340-n, AGC loop units 330-1 through 330-n, and D/A converters 350-1 through 350-n.

The RF/IF units 320-1 through 320-n amplify the RF signals that are externally and wirelessly received through the array antennas 310-1 through 310-n, downconvert the frequency, output IF signals to the A/D converters 340-1 through 340-n, convert the IF signals output from the D/A converters 350-1 through 350-n into RF signals, and externally and wirelessly transmit the RF signals through the array antennas 310-1 through 310-n.

Since the A/D converters 340-1 through 340-n and the AGC loop units 330-1 through 330-n operate in a manner very similar to the first preferred embodiment of the present invention as shown in FIG. 4, no further description will be provided.

The D/A converters 350-1 through 350-n convert the signals output from the baseband unit 400 into analog signals, and output the analog signals to the RF/IF units 320-1 through 320-n.

The baseband unit 400 uses the signals output from the signal converter 300 to generate beam-forming signals having equal power levels, temporally and spatially dispreads them, performs channel estimation, performs coherent demodulation, performs combining and decoding to output final signals to a digital demodulator (not illustrated), receives input signals from the digital demodulator, converts the channel-encoded signals on the basis of the power ratio of the received beam-forming signals, generates transmission beam-forming signals, and outputs them to the signal converter 300.

The baseband unit 400 comprises receiving matched filters 410-1 through 410-n, a receiving beam former 420, a beam gain controller 430, a finger bank 440, a combiner/decoder bank 450, a beam path searcher 460, a controller 470, a channel encoder bank 480, a modulator bank 490, a transmission beam former 500, and transmission matched filters 510-1 through 510-n.

Here, since the transmission matched filters 510-1 through 510-n, the receiving beam former 420, the beam gain controller 430, the finger bank 440, the combiner/decoder bank 450, and the beam path searcher 460 operate in an identical manner of the first preferred embodiment of the present invention as shown in FIG. 4, no further detailed description will be provided.

That is, it is already fully described from the first preferred embodiment of the present invention that the beam gain controller 430 uses the multipliers 431-1 through 431-m, the power measurers 433-1 through 433-m, and the gain controllers 435-1 through 435-m to control the power levels of the beam-forming signals generated from the receiving beam former 420 to be equal, and inputs the signals to the fingers 441-1 through 441-m of the finger bank 440 so that the combiner/decoder bank 450 may combine them with the maximal ratio thereby maximizing the receiving performance.

Therefore, descriptions that are not provided in the first preferred embodiment of the present invention will now be provided.

The channel encoder bank 480 uses a corresponding code to perform channel encoding on the inputs from a digital demodulator (not illustrated), and outputs Nᵤₛₑᵣ (=x) signals to the modulator bank 490.

In order to maintain the power levels of the received signals equally, that is, the power levels of the beam-forming signals output from the receiving beam former 420, the controller 470 periodically receives information on the ratio of the signals output to the multipliers 431-1 through 431-m from the gain controllers 435-1 through 435-m, inversely calculates the power ratios of the respective received signals, and transmits information on the calculated power ratios to the modulator bank 490.

The modulator bank 490 uses the information on the power ratios of the received signals transmitted from the controller 470 to modulate the x signals output from the channel encoder bank 480 into m signals, output the m signals to the transmission beam former 500, and thus obtains a desired direction of the modulation signals.

The transmission beam former 500 changes the m signals output from the modulator bank 490 into n transmission beam-forming signals, and outputs them to the transmission matched filters 510-1 through 510-n.

The transmission matched filters 510-1 through 510-n match the digital signals output from the transmission beam former 500, and output them to the signal converter 100.

In the mobile array antenna system according to the second preferred embodiment of the present invention, the beam gain controller 430 uses the power measurers 433-1 through 433-m, the gain controllers 435-1 through 435-m, and the multipliers 431-1 through 431-m to control the power levels of the m signals output from the beam former 420 to be equal, thereby maximizing the receiving performance. It also uses the fact that the ratios of the reciprocals of the signals output from the gain controllers 435-1 through 435-m become the power ratios of the received signals for the respective beams, and it uses information on the power ratios of the received signals periodically reported from the controller 470 to enable the modulator bank 490 to control the signals output from the channel encoder bank 480 and input to the transmission beam former 500 (i.e., applying to transmission beam forming), thereby maximizing the transmission performance.

For example, when the mobile array antenna system according to the second preferred embodiment of the present invention is applied to a base station system, the number of mobile stations is different for the respective beams under the state that four switching beams are provided as shown in FIG. 2. The directions of the received signals of the base stations form transmission beams with respect to the mobile stations 31 in the second and third beams, and information on the power ratios of the received signals of the second and third beams is used to increase the transmission power in the direction of the beam that has a relatively low power level of the received signals, that is, in the direction of the third beam, thereby improving the transmission performance.

According to the present invention, receiving performance is maximized by maintaining the power levels of the received signals of the respective beams, and a maximal ratio combination is obtained when forming the beams of the received signals.

Also, transmission performance is maximized by using information on the power ratios of the received signals of the respective beams provided from a receiver, and by applying the information to formation of transmission beams.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An array antenna system for mobile communication, comprising:
a signal converter for performing frequency downconversion and digital signaling on radio signals received from multiple paths through a plurality of array antennas; and
a baseband unit for using signals output from the signal converter to generate beam-forming signals having equal power levels, temporally and spatially performing dispreading, performing channel estimation, performing coherent demodulation, and performing combining and decoding to output final signals.

2. The system of claim 1, wherein the signal converter comprises:
a frequency converter for respectively amplifying the signals received through the array antennas, downconverting the frequency, and outputting signals;
an A/D converter for converting the respective signals output from the frequency converter into digital signals, and outputting the digital signals to the baseband unit; and
an automatic gain controller for controlling the frequency converter on the basis of the respective output signals of the A/D converter so that the respective signals output to the A/D converter from the frequency converter may be matched with an input level of the A/D converter.

3. The system of claim 1, wherein the baseband unit comprises:
a beam former for using the respective signals output from the signal converter to change them into beam-forming signals of a predetermined number, and outputting changed signals;
a beam gain controller for receiving the beam-forming signals from the beam former, controlling power levels for the respective beams to be equal, and outputting signals;
a finger bank for temporally and spatially dispreading the beam-forming signals output from the beam gain controller, performing channel estimation, and performing coherent demodulation;
a combiner/decoder bank for performing combining and decoding on the output signals of the finger bank, and outputting final signals to a digital demodulator;
a beam path searcher for using the beaming forming signals output from the beam gain controller to perform a beam path search; and
a controller for controlling the operation of the finger bank according to output signals of the beam path searcher.

4. The system of claim 3, wherein the beam gain controller comprises:
a multiplier for multiplying the beam-forming signals output from the beam former by a predetermined gain control signal, and outputting result signals to the finger bank;
a power measurer for measuring power levels of the respective signals output from the multiplier; and
a gain controller for outputting the gain control signal to the multiplier for each beam-forming signal so that the power levels of the respective signals measured by the power measurer may be equal.

5. The system of claim 4, wherein ratios of the reciprocals of the gain control signals for the respective beam-forming signals with the predetermined number output to the multiplier from the gain controller become power ratios of the beam-forming signals with the predetermined number output from the beam former.

6. An array antenna system for mobile communication, comprising:
a baseband unit for receiving signals input for mobile transmission, performing channel encoding on them, modulating the channel encoded signals on the basis of information on power ratios of externally input receiving beam-forming signals, generating transmission beam-forming signals, and outputting them; and
a signal converter for converting the signals output from the baseband unit into analog signals, upconverting the frequency, and wirelessly transmitting the analog signals through a plurality of array antennas in multiple paths.

7. The system of claim 6, wherein the baseband unit comprises:
a channel encoder bank for using a code matched with the input signal to perform channel encoding;
a modulator bank for using information on the power ratios of the externally input receiving beam-forming signals to control power levels of the respective signals input from the channel encoder bank, and outputting signals; and
a beam former for changing the signals output from the modulator bank into transmission beam-forming signals of a predetermined number, and outputting the signals to the signal converter.

8. The system of claim 6, wherein the signal converter comprises:
a D/A converter for converting the signals output from the baseband unit into analog signals, and outputting them; and
a frequency converter for performing frequency upconversion on the signals output from the D/A converter, and wirelessly transmitting them to the outside through the array antennas.

9. The system of claim 6, Wherein the information on the power ratios of the externally input receiving beam-forming signals is generated on the basis of the power level information measured from the receiving beam-forming signals generated from radio receiving signals.

10. A mobile array antenna system comprising:
a signal converter for receiving radio signals through a plurality of array antennas in multiple paths, performing frequency downconversion on them, performing digital signaling, converting the signals input for wireless transmission through the array antennas into analog signals, and performing frequency upconversion; and
a baseband unit for using the signals output from the signal converter to generate receiving beam-forming signals having equal power levels, temporally and spatially performing dispreading, performing channel estimation, performing coherent demodulation, performing combining and decoding to output final signals, receiving signals input for wireless transmission and performing channel encoding on them, modulating the channel encoded signals, generating transmission beam-forming signals, and outputting them to the signal converter on the basis of information on the power levels of the receiving beam-forming signals used for the receiving beam-forming signals to have equal power levels.

11. The system of claim 10, wherein the signal converter comprises:
a frequency converter for respectively amplifying the signals received through the array antennas, downconverting the frequencies thereof, outputting them, performing upconversion on the signals output from the baseband unit, and wirelessly and externally transmitting result signals through the array antennas;
an A/D converter for converting the respective signals output from the frequency converter into digital signals, and outputting the digital signals to the baseband unit;
an automatic gain controller for controlling the frequency converter on the basis of the respective output signals of the A/D converter so that the respective signals output to the A/D converter from the frequency converter may be matched with an input level of the A/D converter; and
a D/A converter for converting the signals output from the baseband unit into analog signals, and providing them to the frequency converter.

12. The system of claim 10, wherein the baseband unit comprises:
a receiving beam former for using the respective signals output from the signal converter to change them into beam-forming signals of a predetermined number, and outputting them;
a beam gain controller for receiving the receiving beam-forming signals from the receiving beam former, controlling power levels of the respective beams to be equal, outputting the signals, and outputting information for controlling the power levels of the receiving beam-forming signals to be equal;
a finger bank for temporally and spatially dispreading the receiving beam-forming signals output from the beam gain controller, performing channel estimation, and performing coherent demodulation;
a combiner/decoder bank for performing combining and decoding on the output signals of the finger bank, and finally outputting them to a digital demodulator;
a beam path searcher for using the receiving beam-forming signals output from the beam gain controller to perform a beam path search;
a controller for controlling the operation of the finger bank according to an output signal of the beam path searcher, generating information on the power ratios of the receiving beam-forming signals on the basis of the information used for controlling the power levels of the receiving beam-forming signals of the predetermined number output from the beam gain controller to be equal, and outputting the information;
a channel encoder bank for using a code matched with a signal input for the wireless transmission to perform channel encoding;
a modulator bank for using information on the power ratios of the receiving beam-forming signals output from the controller to control power levels of the respective signals output from the channel encoder bank, and outputting signals; and
a transmission beam former for changing the signals output from the modulator bank into transmission beam-forming signals of a predetermined number, and outputting them to the signal converter.

13. The system of claim 12, wherein the beam gain controller comprises:
a multiplier for multiplying the receiving beam-forming signals of the predetermined number output from the receiving beam former by a predetermined gain control signal, and outputting result signals;
a power measurer for measuring power levels of the respective signals output from the multiplier; and
a gain controller for outputting the predetermined gain control signal to the multiplier for the respective receiving beam-forming signals of the predetermined number so that the power levels of the respective signals measured by the power measurer may be equal.

14. The system of claim 13, wherein the information on the power ratios of the respective receiving beam-forming signals is determined by ratios of reciprocals of the predetermined gain control signals for the respective beam-forming signals of the predetermined number output to the multiplier from the gain controller.
